(19) United States
(12) Patent Application Publication
(10) Pub. No.: US 2012/0050789 A1
(43) Pub. Date: Mar. 1, 2012

(54) Dynamically Generated Digital Photo Collections

(75) Inventors: William Martin Bachman, San Jose, CA (US); Joshua David Fagans, Redwood City, CA (US); Eric Hanson, Emeryville, CA (US); Mark Lee Kawano, San Mateo, CA (US); Rachel A. Roth, San Francisco, CA (US)

(73) Assignee: APPLE INC., Cupertino, CA (US)

(21) Appl. No.: 12/872,273

(22) Filed: Aug. 31, 2010

(51) Int. Cl. G06F 3/12; G06F 3/048

(52) U.S. Cl. 358/1.15; 715/810

(57) ABSTRACT

Among other things, methods, systems and computer program products are disclosed for manipulating media. In one aspect, a representation of a bookshelf having a plurality of shelves is displayed. A collection of pre-generated digital photo collections is accessed. A plurality of digital photo collections is displayed, wherein the digital photo collections are positioned on the bookshelf, wherein the digital photo collections represent types of printed media, and wherein the displayed digital photo collections include at least one digital photo collection that was created based on user input and at least one pre-generated digital photo collection. User input indicating a selection of a pre-generated digital photo collection is received. User input indicating an image to be included in the selected pre-generated digital photo collection is received. A digital photo collection is generated based on the selected pre-generated digital photo collection that includes the user indicated image.

### BACKGROUND

This application relates to the generation and display of personalized media items. For example, image design software can be used to create personalized photo albums. The image design software can allow users to add images or text to a personalized photo album and print copies of the personalized photo album. In some implementations, the image design software can provide stock images or photos that can be included in personalized media items.

In some instances, users are allowed to change design aspects of a personalized media item. For example, a user can select a color for a personalized calendar. As another example, a user can select a border design for a personalized post card. In some cases, a system allows a user to store designs for personalized media items and retrieve previously created designs for personalized media items.

### SUMMARY

Methods, systems and computer program products are described for to the generation and display of personalized media items.

In one aspect, a representation of a bookshelf having a plurality of shelves is displayed. A collection of pre-generated digital photo collections is accessed. A plurality of digital photo collections is displayed, wherein the digital photo collections are positioned on the bookshelf, wherein the digital photo collections represent types of printed media, and wherein the displayed digital photo collections include at least one digital photo collection that was created based on user input and at least one pre-generated digital photo collection. User input indicating a selection of a pre-generated digital photo collection is received. User input indicating an image to be included in the selected pre-generated digital photo collection is received. A digital photo collection is generated based on the selected pre-generated digital photo collection that includes the user indicated image.

Implementations can optionally include one or more of the following features. The at least one pre-generated digital photo collection can be a template for a printed media item. The represented types of printed media can include one or more of a book, a greeting card and a calendar. User input indicating one of the displayed digital photo collections can be received. Communication with a printing device can be initiated to cause a printed media item represented by the selected digital photo collection to be printed. The bookshelf can be associated with a first user. User input indicating one of the digital photo collections can be received. The indicated digital photo collection can be provided to a second user to allow the indicated digital photo collection to be displayed on a representation of a bookshelf associated with the second user.

The at least one pre-generated digital photo collection can be positioned on a top shelf of the bookshelf and all digital photo collections in the set of digital photos collections that have been created based on user input can be positioned below the top shelf. User input indicating a selection of one of the digital photo collections can be received. A user can be allowed to edit one or more aspects of the selected digital photo collection. An aspect of the selected digital photo collection can be edited in response to received user input. Changing an aspect of the second digital representation can include removing an image from or adding an image to the second digital representation. The selected digital photo collection can be repositioned on the bookshelf in response to the changing of the aspect of the selected digital photo collection. User input indicating a selection of one of the digital photo collections can be received. User input indicating a change of position for the selected digital photo collection with respect to the bookshelf can be received. The selected digital photo collection can be displayed so as to be positioned on the bookshelf to reflect the user indicated change of position.

In another aspect, a representation of a bookshelf having a plurality of shelves is displayed. One or more digital photo collections is dynamically generated using one or more photos automatically selected from a user photo library, wherein the dynamically generated digital photo collection is associated with an event common to the automatically selected user photos. A plurality of digital photo collections is displayed positioned on the bookshelf wherein the digital photo collections represent types of printed media, and wherein the displayed digital photo collections include at least one dynamically generated digital photo collection and at least one digital photo collection that was created based on user input.

Implementations can optionally include one or more of the following features. User input indicating one of the displayed digital photo collections can be received. Communication with a printing device can be initiated to cause a printed media item represented by the selected digital photo collection to be printed. User input indicating a selection of one of the digital photo collections can be received. User input indicating a change of position for the selected digital photo collection with respect to the bookshelf can be received. The selected digital photo collection can be displayed such that the selected digital photo collection is positioned on the bookshelf to reflect the user indicated change of position.

The represented types of printed media can include one or more of a book, a greeting card and a calendar. The event can comprise a calendar event. A set of photos in the user photo library having associated geographic location metadata can be identified, wherein the geographic location metadata indicates that the photos in the set of photos are associated with a single geographic area. Dynamically generating the dynamically generated digital photo collection can include populating the dynamically generated digital photo collection with one or more photos from the set of photos. The single geographic area can be different than an identified home geographic area for a user. A set of photos in the user photo library having associated time stamp metadata can be identified, wherein the time stamp metadata indicates that the photos in the set of photos are associated with a single time period. Dynamically generating the dynamically generated digital photo collection can include populating the dynamically generated digital photo collection with one or more photos from the set of photos.

The single time period can include a set of one or more consecutive days associated with the event. The event can comprise a calendar event and the single time period is associated with the calendar event. The dynamically generated digital photo collection can be positioned on a top shelf of the bookshelf and all digital photo collections in the set of digital photos collections that have been created based on user input can be positioned below the top shelf. Dynamically generating the dynamically generated digital photo collection can include identifying user preferences using the at least one digital photo collection created based on user input and using the user preferences to dynamically generate the dynamically generated digital photo collection. The user preferences can include an indication of one or more persons to include in photos included in the dynamically generated digital photo collection. User input indicating a selection of one of the digital photo collections can be received. A user can be allowed to edit one or more aspects of the selected digital photo collection. An aspect of the selected digital photo collection can be changed in response to received user input.

The subject matter described in this specification may provide one or more of the following potential advantages. Digital representations of printed media items can be efficiently organized and displayed. Digital photo collections can be dynamically generated based identified user preferences. Images associated with an event can be identified and grouped into digital photo collections. Digital photo collections representing types of printed media can be displayed in a visually pleasing manner.

The subject matter described in this specification can be implemented as a method or as a system or using computer program products, tangibly embodied in computer readable medium, such as a CD-ROM, a DVD-ROM, a semiconductor memory, and a hard disk. Such computer program products may cause a data processing apparatus to conduct one or more operations described in this specification.

In addition, the subject matter described in this specification can be implemented as a system including a processor and a memory coupled to the processor. The memory may encode one or more programs that cause the processor to perform one or more of the method acts described in this specification. Further the subject matter described in this specification can be implemented using various data processing machines.

### BRIEF DESCRIPTION OF THE DRAWINGS

FIG. 1 shows an example keepsake shelf for displaying a plurality of digital photo collections.

FIG. 2 shows an example keepsake shelf for displaying a plurality of digital photo collections having a top shelf for dynamically generated content.

FIG. 3 is a flow diagram of an example process for displaying a plurality of digital photo collections.

FIG. 4 is a flow diagram of an example process for generating digital representations of printed items.

FIG. 5 is a block diagram of a computing device and system that can be used in connection with computer-implemented methods and systems described in this document.

Like reference symbols and designations in the various drawings indicate like elements.

### DETAILED DESCRIPTION

Techniques, apparatus, systems and computer program products are described for providing an interface for displaying and organizing digital photo collections. The digital photo collections can include digital representations of books, greeting cards, post cards, and calendars. The digital photo collections can be arranged on a digital book shelf to allow users to readily organize and browse the digital photo collections. In some cases digital photo collections can be dynamically generated using images obtained from a store or user images. In some implementations, the dynamically generated digital photo collections are associated with events. In some implementations, the dynamically generated digital photo collections are generated using identified user preferences.

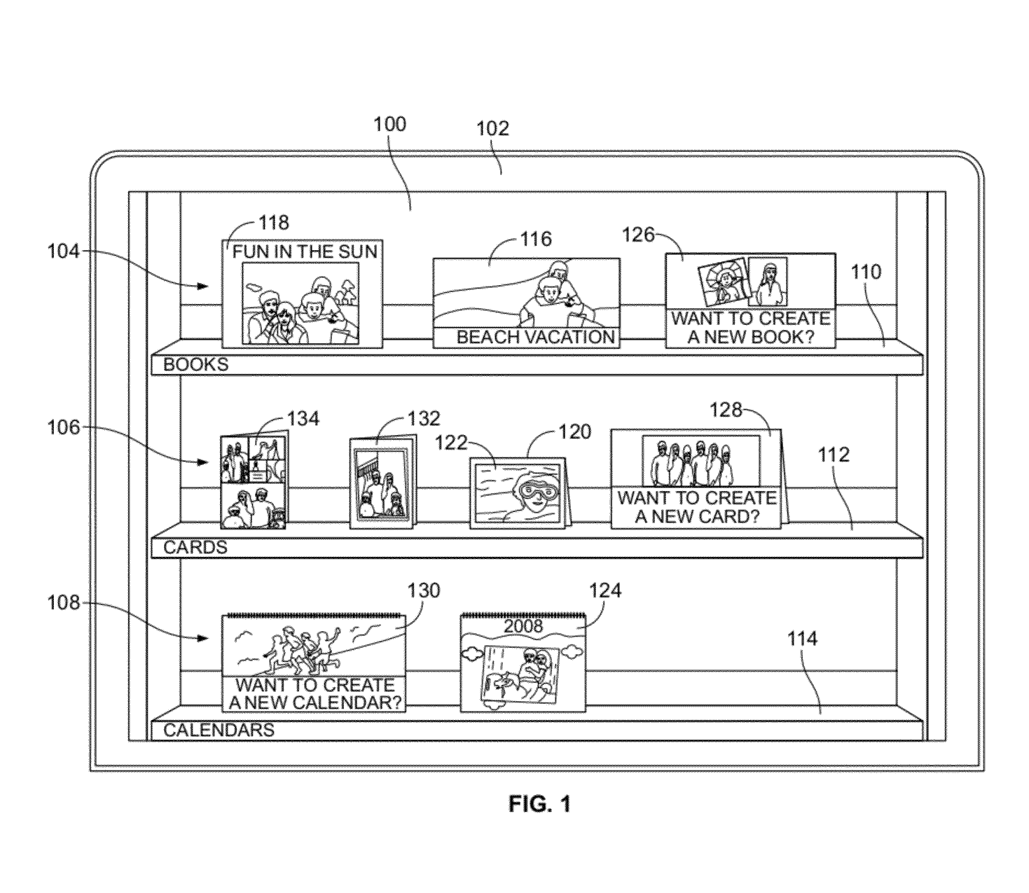

FIG. 1 shows a bookshelf 100 displayed on a display screen 102. The display screen 102 can be, for example, a computer monitor, TV, or mobile device display screen. A number of printed media items including books 104, cards 106, and calendars 108, are positioned on shelves of the bookshelf 100. In the example shown the printed media items are divided by type, with the books 104 displayed on a shelf 110, the cards 106 displayed on a shelf 112, and the calendars 108 displayed on a shelf 108. In some implementations, different types of printed media items are positioned on the same shelf. For example books and cards can be positioned together on the same shelf.

In some implementations, a user can reposition the printed media items. For example, the user can drag a book 116 so that is positioned to the left of a book 118. The book 118 can be automatically repositioned in response to the user input so that the books 104 remain equally spaced apart in order to create an aesthetically pleasing arrangement on the shelf 110. As another example, the user can drag the book 116 to the shelf 112 to cause the book 116 to be displayed on the shelf 112.

In the example shown, each of the printed media items on the bookshelf 100 includes one or more photos. For example, a card 120 includes a photo 122 displayed on the front of the card 120. As another example, the book 118 is labeled “Fun in the Sun” and includes summer, beach, or outdoor related photos. In some implementations, the photos are selected from a collection of user photos. For example, the photo 122 can be selected from a photo directory stored on a computing device associated with the display screen 102. As another example, the photos in the book 118 can be obtained from a network storage location, such as, for example, a photo sharing web site or social networking web site.

In some implementations, some or all of the printed media items are photo collections that have been generated based on user input. For example, a calendar 124 is created by a user. The user can initiate the creation of the calendar 124 by selecting a “create new item” icon or by selecting an option for “create new calendar” from a menu. In some implementations, the user can browse through a collection of calendar templates having various themes in order to select a calendar template having a desired theme. The user can then create a customized calendar by adding text and photos to a selected template. For example, the user can drag a desired photo from a picture directory over a page of a calendar to add the desired photo to the page. The user can also add captions to photos or other text to pages of the calendar. In some implementations, the user can change the theme of a calendar after customizing some or all of the pages (e.g., with images and text). In some implementations, the user can select different themes for different pages of the calendar. For example, the user can select a winter theme for January, a beach theme for June, and a birthday theme for a month in which a child of the user was born.

In some implementations, the user can create personalized printed media items by editing aspects of existing printed media items. For example, the user can select the previously created calendar 124 and add new photos to one or more of the pages of the calendar 124. As another example, the user can import already created cards 106 (e.g., by loading from a CD-ROM or downloading from a web server). The user can edit text and/or photos of the imported cards 106 to create personalized greeting cards. For example, the user can replace a generic winter landscape photo of a greeting card with a family picture. As another example, the user can replace a generic beach photo on a post card with a photo taken by the user on a beach vacation. As yet another example, the user can change generic text of a birthday card in order to create a personalized greeting.

In some implementations, one or more shelves of the bookshelf 100 can be populated with pre-generated printed media items. For example, professionally designed printed media items having various themes (e.g., “baby's first year,” or “summer baseball league”) can be arranged on one or more shelves as sample printed media item projects. A user can browse through the professionally designed printed media items and select an item to use as a starting point for a custom printed media item. The user can then populate the selected printed media item with photos from a collection of user photos. In some implementations, a printed media item creation manager can guide a user through the process of modifying a pre-generated printed media item with user provided photos and other custom attributes.

In some implementations, one or more of the printed media items displayed on the bookshelf 100 are dynamically generated. For example, a book 126 is dynamically generated by a system in communication with the display screen 102 (e.g., a personal computer, a mobile device, or a web server). In some implementations, the dynamically generated book 126 is created using stock images and generic text. For example, a generic landscape photo can be used for the cover of the dynamically generated book 126.

In some implementations, images taken from one or more collections of user images are used to dynamically generate the dynamically generated book 126. For example, a directory of user images located on the user's computer can be accessed. Photos and other images can be selected from the directory and used to populate the dynamically generated book 126. As another example, photos stored on the user's mobile phone can be accessed and used to populate the dynamically generated book 126. As yet another example, photos included as part of a social networking profile for the user can be identified and used to populate the dynamically generated book 126. In some implementations, photos included as part of social networking profiles of persons identified as friends or contacts of the user can be used to populate the dynamically generated book 126.

In some implementations, a printed media item can be dynamically generated in association with an event. For example, if the winter holiday season is approaching, a holiday themed card can be dynamically generated. As another example, a patriotic themed card can be dynamically generated if Independence Day is approaching. As yet another example, the dynamically generated book 126 can be created for a vacation that the user had taken. As another example, a calendar application, or a social networking web site can be used to identify an upcoming birthday of a friend or family member of the user. A card 128 can then be dynamically generated for the identified birthday.

In some implementations, information associated with photos and other images is used to identify photos or images to be used in a dynamically generated printed item. For example, a Christmas card can be automatically generated around the beginning of December. The Christmas card can be associated with a family theme. Metadata associated with photos in a collection of user photos can be used to identify a photo of the user's family to include in the Christmas card. For example, a photo having a caption of “Family Picture” can be identified and automatically selected for inclusion in the Christmas card. As another example, profile information associated with the user can be used to identify names for the user's spouse and children. Photos posted on a social networking site that have been tagged as including the user, the user's spouse, and the user's children can be identified and one or more of the identified photos can be included in the Christmas card. As yet another example, face recognition software can be used to identify the user and the user's family members in one or more photos which can then be included in the dynamically generated Christmas card.

As another example of identifying photos to include in a dynamically generated printed media item, an upcoming birthday for the user's mother can be identified. The card 128 can be dynamically generated in response to the birthday. The card 128 can be generated to have a birthday theme. For example, pre-generated text that is directed towards a mother on her birthday can be identified and included in the card 128 since the upcoming birthday is for the user's mother. As another example, text that includes a joke about being old can be included in the card 128 since it can be assumed that the user's mother is older than the user. An archive of photos can then be searched to identify one or more photos that include the user and the user's mother (e.g., using tagging information, caption information, or face recognition software). In some instances, face recognition software can be used to identify a photo that includes a close up shot of the user and the user's mother. The identified photo can then be automatically placed on the front of the card.

In some implementations, the user can edit aspects of a dynamically generated printed media item in order to create a customized printed media item. For example, following the example above of the card 128 dynamically generated for the user's mother's birthday, the user can select the card 128 to enter into an edit mode. The user can elect to edit text of the card to be specific to the user or the user's mother. The user can also replace one or more images of the card with other images. For example, the card 128 can be dynamically generated to include a photo of the user and the user's mother as described above. The user can elect to replace this photo with a photo of the user's children.

As another example of identifying photos to include in a dynamically generated printed media item, a calendar entry can indicate that the user is throwing a party in the near future. A card 128 can be dynamically generated as an invitation to the party. Social networking information associated with the user can be used to identify friends of the user (e.g., people the user interacts with often that are near the user's age). Photos that include the identified friends of the user can be selected and automatically included in the dynamically generated invitation.

In some implementations, time stamp information associated with images can be used to identify images for inclusion in a dynamically generated printed media item. For example, calendar information can be used to determine that family reunion for the user has recently occurred. Examples of calendar information that can be used can include a calendar entry made on a calendar associated with the user or an event notice posted on a social networking web site. The calendar information can be used to identify a date for the family reunion. One or more collections of user photos can be accessed and time stamp information associated with the photos can be used to identify photos taken on the day of the family reunion. Some or all of the identified photos can be used to populate the dynamically generated book 126.

In some implementations, face recognition software can be used to identify persons in the photos. The photos can then be captioned in the dynamically generated book 126 with the names of the identified photos. In some implementations, caption information associated with photos included in the dynamically generated book 126 can be used to caption the photos within the dynamically generated book 126. In some implementations, calendar information can be used to create text for the dynamically generated book 126. For example, a title of a calendar entry for the family reunion can read “Smith Family Reunion.” The dynamically generated book 126 can be titled “Smith Family Reunion” on a front cover or first page of the book 126.

In some implementations, calendar information, profile information, or information associated with selected photos can be used to select or create a theme for the dynamically generated book 126. For example, a calendar entry for the family reunion can indicate that the family reunion has a luau theme. A luau, tropical, or beach theme can then be identified for the dynamically generated book 126. A luau theme can include, for example, images of pineapples, grass skirts, leis, palm trees, and hula dancers. As another example, a social networking web site event page for the family reunion can indicate that the family reunion is a ski trip. A winter or skiing theme can be identified for the dynamically generated book 126. As yet another example, caption information or other metadata associated with photos selected for the dynamically generated book 126 can indicate that the family reunion was a barbeque. A barbeque or summer theme can be selected for the dynamically generated book 126.

In some implementations, time stamp information associated with images can be used to identify a time period of concentrated image creation (e.g., photo taking). For example, historic information associated with the user can be used to determine that the user generally takes only three or four photos per week. Time stamp information associated with photos in a directory of user photos can be used to identify that a large number of photos where taken over the course of the previous evening. Since the large number of photos taken in a finite time period is outside of the normal picture taking habits of the user, this can indicate that an event had occurred the previous night. For example, the user may have attended a party or had a night out with friends and taken a large number of pictures. A printed media item can be dynamically generated in response to the event and populated with photos taken during the identified time period. For example, the dynamically generated book 126 can be created in response to the user taking 40 pictures over the course of the previous night. The dynamically generated book 126 can be populated with some or all of the photos taken during this time period. In some implementations, face recognition software can be used to identify persons in the photos. The photos can then be captioned with the names of the identified persons.

In some implementations, location information associated with images can be used to identify images for a dynamically generated printed media item. For example, a home location for the user can be identified using profile information associated with the user. As another example, geographic location information associated with user photos can indicate that most of the photos associated with the user are taken in and around Salt Lake City, Utah. This information can be used to identify Salt Lake City, Utah as a likely home location for the user. A set of user photos can be associated with geographic information indicating that the photos were taken in Jamaica. This information can be interpreted to determine that the user took a vacation or other trip to Jamaica. A calendar 130 can be dynamically generated in association with the identified trip to Jamaica and populated with photos identified as having been taken in Jamaica. In some implementations, a vacation theme or a beach theme can be used when dynamically generating the calendar 130 to correspond to the theme of the vacation photos used in the calendar 130.

In some implementations, location information associated with photos included in a dynamically generated printed media item can be used to identify specific cities or locations where the photos were taken. This information can then be used to create captions for the photos in the dynamically generated printed media item. For example, a photo taken on Seven Mile Beach can be captioned as such. As another example, GPS information associated with a photo can indicate an address where the photo was taken. Address book information can be used to identify the address as being associated with a contact of the user named “Alex.” The photo can be labeled “At Alex's house” in a dynamically generated printed media item.

As another example, location information associated with a set of photos can be used to determine that the photos were taken in Aspen, Colo. The photos can be identified as most likely corresponding to a ski trip. In some implementations, the photos can be tagged with location information by the user or by other users. In some implementations, the photos can be taken by a camera or other device having GPS functionality. The camera or other device can automatically tag the photos with location information determined using GPS signals. The dynamically generated book 126 can be dynamically created in response to the identified ski trip and populated with some or all of the photos in the set of photos.

In some implementations, the user can make several trips to the same location. For example, the user may take an annual ski trip to Aspen, Colo. In some such cases, photos identified as having been taken in Aspen, Colo. that are associated with a specific time period can be identified for inclusion in a dynamically generated printed media item. For example, a gap of 48 weeks can be identified between a first set of photos taken in Aspen and a second set of photos taken in Aspen. This identified gap can be used to separate the photos into the two sets and identify the photos as being associated with two different trips. Photos associated with the more recent of the two trips can be used to populate a dynamically generated printed media item. This can lead to a more please photo viewing experience for the user since the photos included in the dynamically generated printed media item are associated with a single trip rather than multiple trips to the same location.

In some implementations, some photos in a collection of user photos are associated with location data while other photos are not. For example, some of the photos have been taken using a camera with GPS functionality for geo-tagging the photos while other photos have been taken using a camera phone that does not have GPS functionality. The photos that are associated with location information can be used to identify that the user has taken a trip to Italy. Time stamp information associated with these photos can be used to determine a time frame for the trip to Italy. Time stamp information associated with other photos that are not associated with location information can be used to identify additional photos that were taken during the time frame of the trip to Italy. In this way, photos that are not associated with location information can be included in a printed media item that is generated in association with the trip to Italy.

In some implementations, rating information or other information can be used to rank photos in an order. The highest ranked photos can then be selected for inclusion in a dynamically generated printed media item. For example, the calendar 130 can be dynamically generated in response to an identified vacation to Jamaica taken by the user. A collection of photos taken in Jamaica can be identified as described above. The photos can be ranked based on ratings given to the photo by the user, or based on number of views the photos have received. For example, the number of views for a photo can be based on the number of times the user has opened the file for the photo, or a number of views a photo has received on a photo sharing or social networking web site. The top thirteen ranked photos can then be selected for inclusion in the calendar 130 (e.g., one for each month plus one for the cover).

In some implementations, user preference information can be derived from one or more printed media items that have been generated based on user input. The user preference information can be used in the creation of dynamically generated printed media items. For example, the user creates the book 116. The book 116 can be used to identify a user preference for group photos. The dynamically generated book 126 can then be dynamically generated (e.g., in response to a recent or upcoming event) and populated primarily or entirely with group photos based on the user preference derived from the book 116.

As another example, the book 116 can be used to identify a user preference for including three or four photos on each page of a book. The dynamically generated book 126 can be dynamically generated with three or four photos on each page. As yet another example, a card 132 can be used to identify a user preference for including landscape photos in greeting cards. The card 128 can be dynamically generated and populated with a photo from a user collection of photos that is identified as being a photo of a landscape. In some cases, the photo is identified as being a photo of a landscape using caption information or other metadata associated with the photo.

In some implementations, user preference information can include preferences for one or more persons to include in a photos in a printed media item. For example, the card 120 and a card 134 can be a winter holiday themed cards. A user preference for including photos of the user's children in winter holiday themed cards can be identified using the cards 120 and 134. The card 128 can be dynamically generated around the time of the winter holidays and populated with one or more photos of the user's children (e.g., identified using tagging information or face recognition software). As another example, the calendar 124 can be used to identify a user preference for including pictures that include the user's and the user's sisters in calendars. The calendar 130 can be dynamically generated (e.g., in response to an approaching new year) and populated with photos that include the user and the user's sisters.

Other examples of user preferences that can be derived from printed media items created based on user input can include page layout preferences, theme preferences, holiday preferences (e.g., the user likes to make President's Day cards), photo order preferences (e.g., most viewed to least viewed, chronological, etc.), and text preferences.

In some implementations, dynamically generated printed media items can be created and displayed on the bookshelf 100 to encourage users to create personalized printed media items. For example, a dynamically generated calendar populated with photos taken in Jamaica can include text that states “Want to create a calendar for your Jamaica trip?” The user can select the calendar to customize aspects of the calendar

As another example, a user preference for sending greeting cards to friends around the beginning of May each year can be identified. Near the beginning of May, a greeting card is dynamically generated and populated with one or more photos identified using user preferences derived from the greeting cards designed in past years. The greeting card can be displayed on the bookshelf 100 along with the text “You created a greeting card for friends last May, would you like to create a Spring greeting card again this year?”

As another example, calendar information can be used to determine that a birthday party for the user's son recently occurred. The book 126 can be dynamically generated in response to the identified birthday party and populated with photos associated with time stamps indicating that the photos were taken on the date of the birthday party. The dynamically generated book 126 is displayed on the bookshelf 100 along with text stating “Want to create a photo album for Sam's birthday party?” The user can select the dynamically generated book 126 to edit the book 126 and create a personalized photo album. For example, the user can change the order of photos in the book 126, add photos to the book 126, delete photos from the book 126, and select photos for the cover of the book 126. The user can additionally change text of the book 126 or add captions to photos in the book 126.

In some implementations, one or more physical copies of a personalized printed media item or a dynamically generated printed media item can be created. For example, the user can create the card 120 and print a copy of the card 120 on a printer. As another example, the book 126 is dynamically generated and then edited by the user. The user can place an order for one or more physical copies of the book 126 with a printing service. The one or more copies of the book can be delivered to the user or to other intended recipients. As another example, the calendar 130 is dynamically generated and the user orders a physical copy of the calendar 130 without editing the dynamically generated calendar 130.

In some implementations, the printed media items can be arranged on the bookshelf 100 according to one or more criteria. For example, the printed media items can be placed on different shelves according to category (e.g., books, cards, calendars) and arranged on the shelves in chronological order of their creation dates or edit dates from left to right. As another example, all of the printed media items are arranged on the shelves in chronological order from left to right and top to bottom regardless of media type. As another example, printed media items generated based on user input can be positioned on the left of the shelf while dynamically generated printed media items are located to the right. As yet another example, printed media items are arranged in chronological order of events associated with the printed media items rather than creation or edit dates for the printed media items. In some implementations, the user can change the arrangement of the printed media items on the bookshelf 100.

In some implementations, a user can share printed media items displayed on the bookshelf 100 with other users. For example, a user can create a family photo album and share the photo album with family members. The family members can then view the photo album on their own respective virtual bookshelves. A family member who receives the photo album can edit the photo album and/or place an order for one or more physical copies of the photo album. Printed media items can be shared among bookshelves associated with various users across a network (e.g., the Internet, a LAN, or a WAN), through a local WiFi or Bluetooth communication link, or through an intermediate server. For example, the creator of a printed media item can load the printed media item to a server and allow other users to access the printed media item in order to include the printed media item on their own respective virtual bookshelves.

In some implementations, the bookshelf 100 can include representations of media items other than printed media items. For example, the bookshelf 100 can include representations of DVDs, video tapes, or other physical video media items. A user can customize a video media item so that the video media item includes video footage provided by the user (e.g., home video clips and the like). The user can place an order for one or more physical copies of the video media item displayed on the bookshelf 100 with a DVD manufacturer. The one or more copies of the video can be manufactured as a DVD delivered to the user or to other intended recipients. As another example, the bookshelf 100 can include a representation of an audio media item, such as a compact disc or record. The user can place an order, for example, with a record manufacturer for one or more physical copies of a record displayed on the bookshelf 100 to be produced.

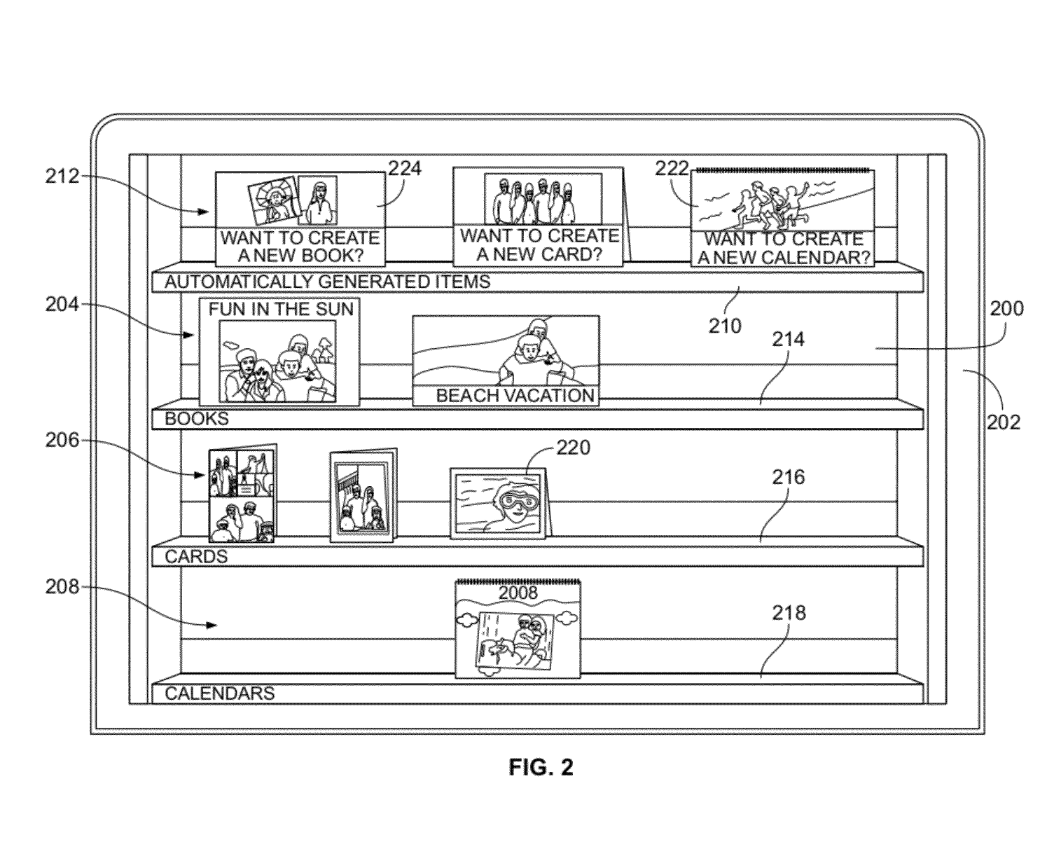

FIG. 2 shows another example of a bookshelf 200 for displaying a plurality of digital photo collections on a display screen 202. Each of the digital photo collections is depicted as a printed media item on the bookshelf 200. For example, the bookshelf 200 includes books 204, cards 206, and calendars 208 arranged on the shelves of the bookshelf 200. The bookshelf 200 includes a top shelf 210 positioned above the other shelves of the bookshelf 200. In the example shown, the top shelf 210 is used to display dynamically generated digital photo collections 212 while the remaining shelves of the bookshelf 100 are used to display digital photo collections that have been created based on user input.

This can help the user to easily identify digital photo collections that have been created by the user, and dynamically generated digital photo collections that are displayed in order to encourage the user to create a new digital photo collection. In some implementations, the digital photo collections positioned on the lower shelves of the bookshelf 100 can be separated by the type of printed media item represented by each digital photo collection. For example, a shelf 214 includes only books, a shelf 216 includes only cards, and a shelf 218 includes only calendars. In other implementations, the digital photo collections are not separated by type. In some implementations a user can determine an arrangement for the digital photo collections on the bookshelf 200. For example, the user can move a card 220 from the shelf 216 to the shelf 218.

In some implementations, the dynamically generated digital photo collections 212 arranged on the top shelf 210 are generated in association with an event as described above with reference to FIG. 1. The dynamically generated digital photo collections 212 can be populated with photos selected from one or more collections of user photos. The photos included in the dynamically generated digital photo collections 212 can be identified as described above with reference to FIG. 1.

In some implementations, the user can select one of the dynamically generated digital photo collections 212 and edit aspects of the selected dynamically generated digital photo collection 212 to create a personalized digital photo collection. For example, the user can select a dynamically generated calendar 222. The user can replace some of the photos in the dynamically generated calendar 222 with other different photos to create a personalized calendar. The user can then save the changes to the calendar.

In some implementations, saving user changes to a dynamically generated digital photo collection 212 can cause the dynamically generated digital photo collection 212 to be repositioned on one of the lower shelves 214-218 of the bookshelf 200 to reflect that the digital photo collection now includes aspects that have specified based on user input. For example, the user can save changes to the calendar 222, this can cause the calendar 222 to be repositioned on the shelf 218 to indicate that user changes have been made to the calendar 222.

In some implementations, digital photo collections can be indicated as saved digital photo collections by being positioned on the lower shelves 214-218 while digital photo collections positioned on the top shelf 210 are not saved. For example, when a user makes changes to a dynamically generated digital photo collection 212 and saves the changes, the changed dynamically generated digital photo collection 212 can be moved to one of the lower shelves 214-218. As another example, the user can drag a dynamically generated book 224 from the top shelf 210 to the shelf 214 to cause the dynamically generated book 224 to be saved even though the user has not made changes to the dynamically generated book 224.

In some implementations, the dynamically generated digital photo collections 212 positioned on the top shelf 210 are replaced with other dynamically generated digital photo collections over time if they are not saved or repositioned on one of the lower shelves 214-218. For example, the bookshelf 200 and digital photo collections can be displayed in response to the user opening a photo collection program. Each time the photo collection program is opened, a different set of dynamically generated digital photo collections can be displayed on the top shelf 210. For example, each time the photo collection program is opened, new dynamically generated digital photo collections are generated in association with recent or upcoming events.

As another example, the dynamically generated digital photo collections 212 are generated and displayed on the bookshelf 200 when the user opens the photo collection program. The user can save the dynamically generated book 224 by moving the dynamically generated book 224 to the shelf 214 and then close the photo collection program. The user can then open the photo collection program again at a different time. In this example, the dynamically generated book 224 is still included on the bookshelf 200 positioned on the 214 while the other dynamically generated digital photo collections 212 are replaced by different dynamically generated digital photo collections. In some implementations, a new dynamically generated book is positioned on the top shelf 210 even though the dynamically generated book 224 is still included on the bookshelf 200.

In some implementations, dynamically generated digital photo collections are indicated in other ways rather than being positioned on the top shelf 210. For example, dynamically generated digital photo collections can be indicated with a special border or icon. Saving or editing one of the dynamically generated digital photo collections can cause the special border or icon to disappear or be replaced with a different border or icon to indicate that the digital photo collection is now saved.

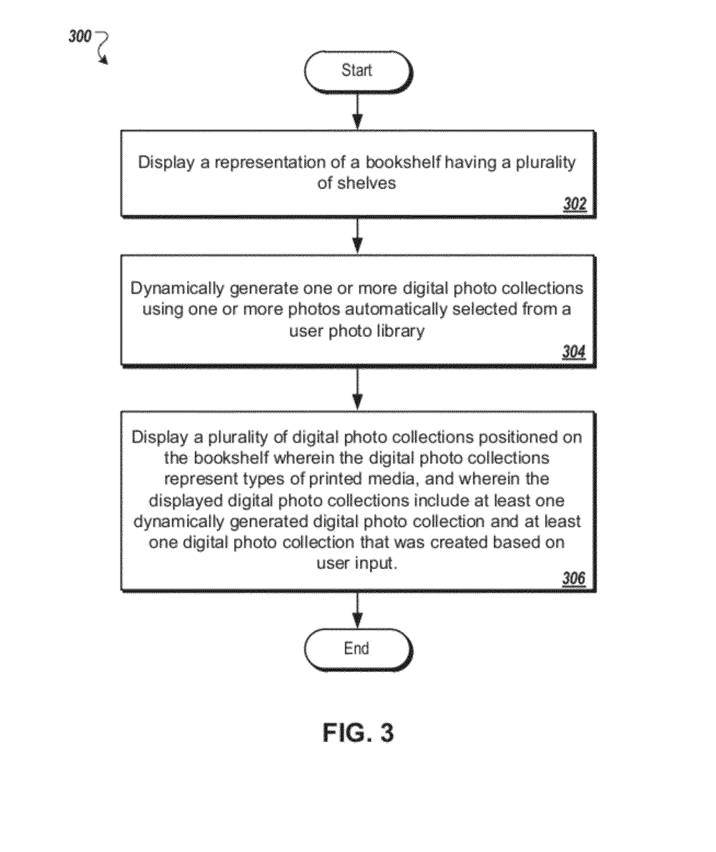

FIG. 3 is a process flow diagram showing an example process 300 for displaying a plurality of digital photo collections. In some implementations, the process 300 can be performed, for example, by a personal computer, a mobile device, or a network server. A representation of a bookshelf having a plurality of shelves is displayed (302). For example, referring to FIG. 1, the bookshelf 100 is displayed on the display screen 102. As another example, a virtual bookshelf is displayed on the display screen of a mobile phone. As yet another example, a digital representation of a bookshelf is displayed on a television.

One or more digital photo collections are dynamically generated using one or more photos automatically selected from a user photo library (304). For example, referring to FIG. 1, the book 126 and the card 128 are automatically dynamically generated and automatically populated with photos selected from a collection of user photos. The user photo library can be, for example, one or more photo directories on a device associated with the user, a photo sharing account associated with the user, or photos that are included as part of a social networking profile for the user. In some implementations, the dynamically generated digital photo collection is associated with an event. For example, a birthday card can be dynamically generated in response to an upcoming birthday for a contact of the user. As another example, a photo album can be generated after a party attended by the user.

In some implementations, the automatically selected photos are associated with the event. For example, the selected photos can be identified as having been taken at a party attended by the user. As another example, the selected photos can be identified as having been taken during a vacation taken by the user. As yet another example, photos including members of the users family can be identified for a dynamically generated Christmas card.

A plurality of digital photo collections are displayed positioned on the bookshelf wherein the digital photo collections represent types of printed media, and wherein the displayed digital photo collections include at least one dynamically generated digital photo collection and at least one digital photo collection that was created based on user input (306). For example, referring to FIG. 2, the dynamically generated digital photo collections 212 are positioned on the top shelf 210 of the bookshelf 200 and several digital photo collections generated based on user input are positioned on the lower shelves 214-218. In some implementations, the dynamically generated digital photo collections are positioned on the bookshelf so as to be separate from the digital photo collections created based on user input. In some implementations, the dynamically generated digital photo collections are displayed interspersed among the digital photo collections created based on user input. In some implementations, user input that can be used to create a digital photo collection can include text entered by the user, images selected by the user, background and border designs selected by the user, themes selected by the user, layouts edited by the user, and image order or arrangement selected by the user.

In some implementations of the process 300, more or fewer steps can be performed or one or more steps can be performed in a different order. For example, the step of dynamically generating one or more digital photo collections can be performed before the step of displaying a representation of a bookshelf. As another example, the process 300 can include additional steps of receiving user input indicating a selection of one of the digital photo collections and changing an aspect of the selected digital photo collection in response to received user input.

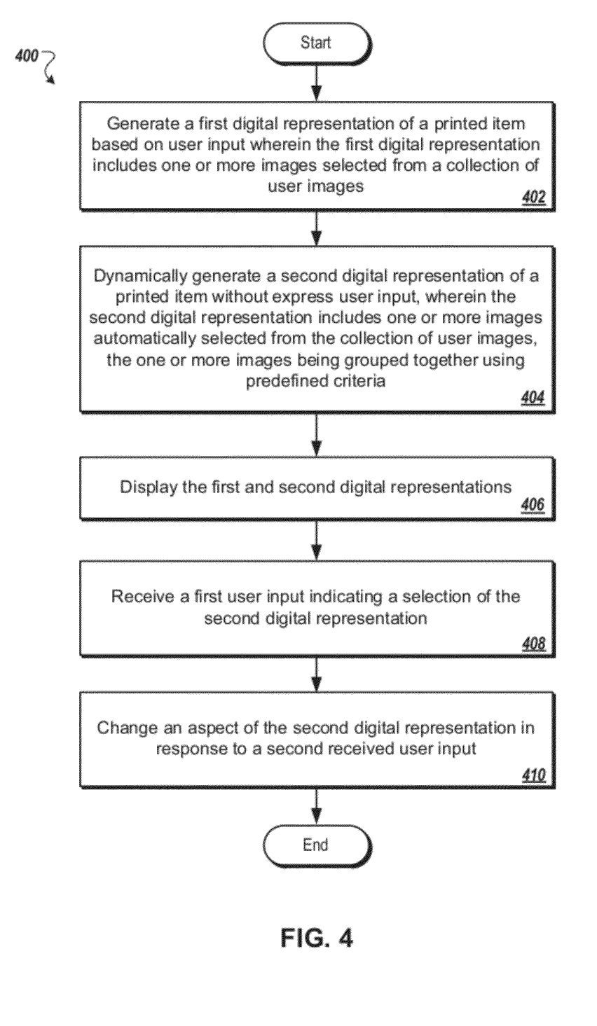

FIG. 4 is a process flow diagram showing an example process 400 for generating digital representations of printed items. In some implementations, the process 400 can be performed for example, by a personal computer, a mobile device, or a network server. A first digital representation of a printed item is generated based on user input wherein the first digital representation includes one or more images selected from a collection of user images (402). For example, referring to FIG. 1, a user selects a menu option to create a new calendar and creates the calendar 124. The user can select a theme, background images, border designs, colors, text, and photos for inclusion in the calendar 124. The user can select images from an images folder on the users computer and use the selected images to populate the calendar 124. In some cases, the collection of user images can include, for example, one or more photo directories on a device associated with the user, a photo sharing account associated with the user, or photos that are included as part of a social networking profile for the user.

A second digital representation of a printed item is dynamically generated without express user input, wherein the second digital representation includes one or more images automatically selected from the collection of user images, the one or more images being grouped together using predefined criteria (404). For example, referring to FIG. 1, the book 126 is dynamically generated without express user input. The book 126 can be automatically populated with photos selected from a store of user images. The selected images included in the second digital representation can be grouped together based on, for example, location, time, persons in the images, time of year, items in the images, image orientation, image file size, or subject matter (e.g., skiing related images, swimming related images, etc.). For example, a group of photos associated with metadata indicating that the photos were taken in Miami, Fla. can be identified for inclusion in the second digital representation. As another example, images of people playing badminton can be identified for inclusion in the second digital representation. As yet another example, images taken during the previous three days can be identified for inclusion in the second digital representation.

The first and second digital representations are displayed (406). For example, referring to FIG. 1, the book 126, the card 128 and the calendar 124 as well as other printed media items are arranged on the shelves of the bookshelf 100. As another example, referring to FIG. 2, the book 224 and the card 220 are displayed on the bookshelf 200. As another example, the first and second digital representations are displayed as being located on a virtual coffee table. As another example, the first and second digital representations are displayed as being attached to a tack board. As yet another example, the first and second digital representations are displayed without a background.

A first user input indicating a selection of the second digital representation is received (408). For example, referring to FIG. 1, the user can use a mouse to click on the book 126. As another example, referring to FIG. 2, the user can use touch screen functionality of the display screen 202 to select the book 224.

An aspect of the second digital representation in response to a second received user input (410). For example, the user can change text included in the second digital representation. As another example, the user can delete photos from and add photos to the second digital representation. As yet another example, the user can change a theme of the second digital representation from a sports theme to a music theme.

In some implementations of the process 400, more or fewer steps can be performed or one or more steps can be performed in a different order. For example, the step of dynamically generating the second digital representation can occur before the step of generating the first digital representation. As another example, the process 400 can include an additional step of communicating with one or more printing devices to cause a physical copy of one of the first and second digital representations to be created.

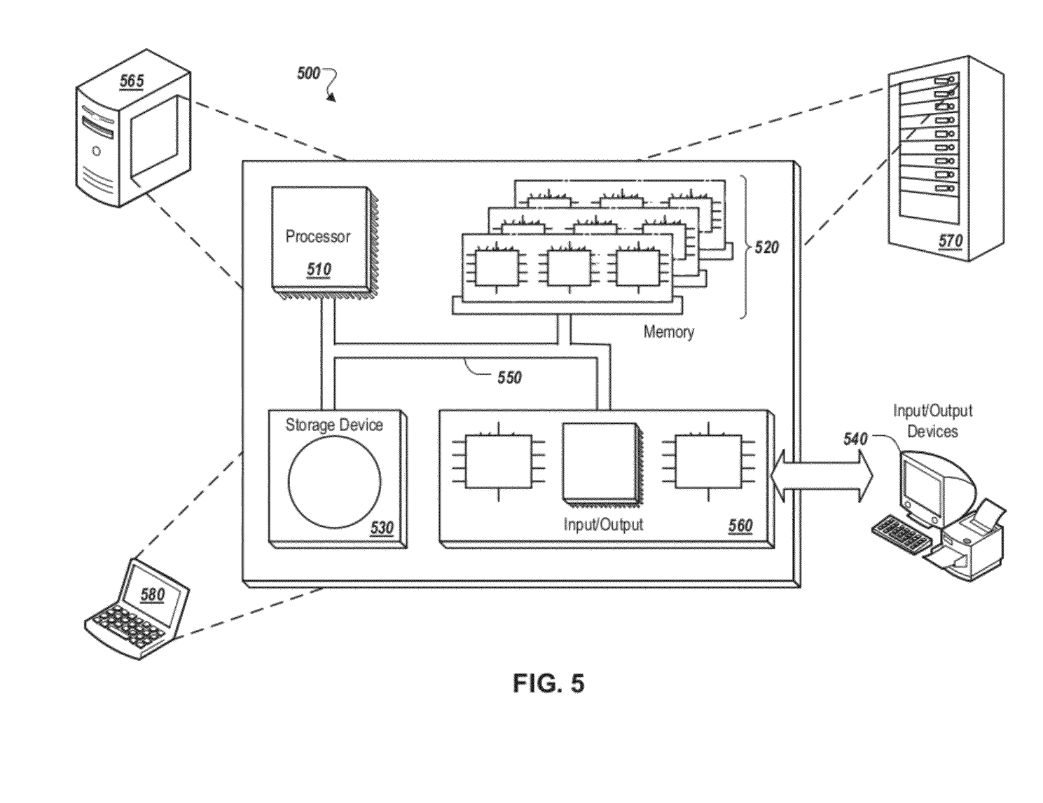

FIG. 5 is a block diagram of a computing device and system that can be used, e.g., to generate and display one or more digital photo collections. Computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 500 includes a processor 510, memory 520, a storage device 530, a high-speed interface 550 connecting to memory 520. The computing device can also include high-speed expansion ports (not shown), and a low speed interface (not shown) connecting to low speed bus (not shown) and storage device 530. Each of the components 510, 520, 530, 550, and 520, are interconnected using various busses, and can be mounted on a common motherboard or in other manners as appropriate. The processor 510 can process instructions for execution within the computing device 500, including instructions stored in the memory 520 or on the storage device 530 to display graphical information for a GUI on an external input/output device, such as display 540 coupled to an input/output interface 560. In other implementations, multiple processors and/or multiple buses can be used, as appropriate, along with multiple memories and types of memory. Also, multiple computing devices 500 can be connected, with each device providing portions of the necessary operations (e.g., as a server bank, a group of blade servers, or a multi-processor system).

The memory 520 stores information within the computing device 500. In one implementation, the memory 520 is a computer-readable medium. In one implementation, the memory 520 is a volatile memory unit or units. In another implementation, the memory 520 is a non-volatile memory unit or units.

The storage device 530 is capable of providing mass storage for the computing device 500. In one implementation, the storage device 530 is a computer-readable medium. In various different implementations, the storage device 530 can be a floppy disk device, a hard disk device, an optical disk device, or a tape device, a flash memory or other similar solid state memory device, or an array of devices, including devices in a storage area network or other configurations. The computer program product contains instructions that, when executed, perform one or more methods, such as those described above. The computer- or machine-readable medium can include the memory 520, the storage device 530, or memory on processor 510.

The high speed controller 550 manages bandwidth-intensive operations for the computing device 500, while the low speed controller manages lower bandwidth-intensive operations. Such allocation of duties is exemplary only. In one implementation, the high-speed controller 550 is coupled to memory 520, display 540 (e.g., through a graphics processor or accelerator), and to high-speed expansion ports (not shown), which can accept various expansion cards (not shown). In the implementation, low-speed controller (not shown) is coupled to storage device 530 and low-speed expansion port (not shown). The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 500 can be implemented in a number of different forms, as shown in the figure. For example, it can be implemented as a standard server 565, or multiple times in a group of such servers. It can also be implemented as part of a rack server system 570. In addition, it can be implemented in a personal computer such as a laptop computer 580.

Implementations of the subject matter and the functional operations described in this specification can be configured in digital electronic circuitry, or in computer software, firmware, or hardware, including the structures disclosed in this specification and their structural equivalents, or in combinations of one or more of them. Implementations of the subject matter described in this specification can be configured as one or more computer program products, i.e., one or more modules of computer program instructions encoded on a tangible computer or machine readable medium for execution by, or to control the operation of, data processing apparatus. The computer readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Only a few implementations and examples are described and other implementations, enhancements and variations can be made based on what is described and illustrated in this application. A number of embodiments have been described. Nevertheless, it will be understood that various modifications are optionally made without departing from the spirit and scope of this disclosure. Accordingly, other embodiments are within the scope of the following claims.

What is claimed is:

1. A computer-implemented method to be performed by one or more processors, the method comprising:
displaying a representation of a bookshelf having a plurality of shelves;
accessing a collection of pre-generated digital photo collections;
displaying a plurality of digital photo collections positioned on the bookshelf wherein the digital photo collections represent types of printed media, and wherein the displayed digital photo collections include at least one digital photo collection that was created based on user input and at least one pre-generated digital photo collection;
receiving user input indicating a selection of a pre-generated digital photo collection;
receiving user input indicating an image to be included in the selected pre-generated digital photo collection;
generating a digital photo collection based on the selected pre-generated digital photo collection that includes the user indicated image.

2. The method of claim 1, wherein the at least one pre-generated digital photo collection is a template for a printed media item.

3. The method of claim 1, wherein the represented types of printed media include one or more of a book, a greeting card and a calendar.

4. The method of claim 1, further comprising:
receiving user input indicating one of the displayed digital photo collections; and
communicating with a printing device to cause a printed media item represented by the selected digital photo collection to be printed.

5. The method of claim 1, wherein the bookshelf is associated with a first user, the method further comprising:
receiving user input indicating one of the digital photo collections;
providing the indicated digital photo collection to a second user to allow the indicated digital photo collection to be displayed on a representation of a bookshelf associated with the second user.

6. The method of claim 1, wherein the at least one pre-generated digital photo collection is positioned on a top shelf of the bookshelf and all digital photo collections in the set of digital photos collections that have been created based on user input are positioned below the top shelf.

7. The method of claim 1, further comprising:
receiving user input indicating a selection of one of the digital photo collections;
allowing a user to edit one or more aspects of the selected digital photo collection;
changing an aspect of the selected digital photo collection in response to received user input.

8. The method of claim 7, wherein changing an aspect of the second digital representation includes removing an image from or adding an image to the second digital representation.

9. The method of claim 7, further comprising repositioning the selected digital photo collection on the bookshelf in response to the changing of the aspect of the selected digital photo collection.

10. The method of claim 1, further comprising:
receiving user input indicating a selection of one of the digital photo collections;
receiving user input indicating a change of position for the selected digital photo collection with respect to the bookshelf;
displaying the selected digital photo collection positioned on the bookshelf to reflect the user indicated change of position.

11. A computer-implemented method to be performed by one or more processors, the method comprising:
displaying a representation of a bookshelf having a plurality of shelves;
dynamically generating one or more digital photo collections using one or more photos automatically selected from a user photo library, wherein the dynamically generated digital photo collection is associated with an event common to the automatically selected user photos; and
displaying a plurality of digital photo collections positioned on the bookshelf wherein the digital photo collections represent types of printed media, and wherein the displayed digital photo collections include at least one dynamically generated digital photo collection and at least one digital photo collection that was created based on user input.

12. The method of claim 11, further comprising:
receiving user input indicating one of the displayed digital photo collections; and
communicating with a printing device to cause a printed media item represented by the selected digital photo collection to be printed.

13. The method of claim 11, further comprising:
receiving user input indicating a selection of one of the digital photo collections;
receiving user input indicating a change of position for the selected digital photo collection with respect to the bookshelf;
displaying the selected digital photo collection positioned on the bookshelf to reflect the user indicated change of position.

14. The method of claim 11, wherein the represented types of printed media include one or more of a book, a greeting card and a calendar.

15. The method of claim 11, wherein the event comprises a calendar event.

16. The method of claim 11, further comprising:
identifying a set of photos in the user photo library having associated geographic location metadata, wherein the geographic location metadata indicates that the photos in the set of photos are associated with a single geographic area;
wherein dynamically generating the dynamically generated digital photo collection includes populating the dynamically generated digital photo collection with one or more photos from the set of photos.

17. The method of claim 16, wherein the single geographic area is different than an identified home geographic area for a user.

18. The method of claim 11, further comprising:
identifying a set of photos in the user photo library having associated time stamp metadata, wherein the time stamp metadata indicates that the photos in the set of photos are associated with a single time period;
wherein dynamically generating the dynamically generated digital photo collection includes populating the dynamically generated digital photo collection with one or more photos from the set of photos.

19. The method of claim 18, wherein the single time period is a set of one or more consecutive days associated with the event.

20. The method of claim 18, wherein the event comprises a calendar event and the single time period is associated with the calendar event.

21. The method of claim 11, wherein the dynamically generated digital photo collection is positioned on a top shelf of the bookshelf and all digital photo collections in the set of digital photos collections that have been created based on user input are positioned below the top shelf.

22. The method of claim 11, wherein dynamically generating the dynamically generated digital photo collection includes identifying user preferences using the at least one digital photo collection created based on user input and using the user preferences to dynamically generate the dynamically generated digital photo collection.

23. The method of claim 22, wherein the user preferences include an indication of one or more persons to include in photos included in the dynamically generated digital photo collection.

24. The method of claim 11, further comprising:
receiving user input indicating a selection of one of the digital photo collections;
allowing a user to edit one or more aspects of the selected digital photo collection;
changing an aspect of the selected digital photo collection in response to received user input.

25. A computer-readable medium tangibly encoding computer software instructions executable by data processing apparatus to perform operations comprising:
displaying a representation of a bookshelf having a plurality of shelves;
accessing a collection of pre-generated digital photo collections;
displaying a plurality of digital photo collections positioned on the bookshelf wherein the digital photo collections represent types of printed media, and wherein the displayed digital photo collections include at least one digital photo collection that was created based on user input and at least one pre-generated digital photo collection;

26. The medium of claim 25, wherein the operations further comprise:
receiving user input indicating a selection of a pre-generated digital photo collection;
receiving user input indicating an image to be included in the selected pre-generated digital photo collection;
generating a digital photo collection based on the selected pre-generated digital photo collection that includes the user indicated image.

27. The medium of claim 25, wherein the at least one pre-generated digital photo collection is a template for a printed media item.

28. The medium of claim 25, wherein the represented types of printed media include one or more of a book, a greeting card and a calendar.

29. The medium of claim 25, wherein the operations further comprise:
receiving user input indicating one of the displayed digital photo collections; and
communicating with a printing device to cause a printed media item represented by the selected digital photo collection to be printed.

30. The medium of claim 25, wherein the bookshelf is associated with a first user, and wherein access to one or more of the digital photo collections is provided to a second user to allow the one or more digital photo collections to be displayed on a representation of a bookshelf associated with the second user.

31. The medium of claim 25, wherein the at least one pre-generated digital photo collection is positioned on a top shelf of the bookshelf and all digital photo collections in the set of digital photos collections that have been created based on user input are positioned below the top shelf.

32. A system comprising:
a data processing apparatus;
a display device configured to display a representation of a bookshelf having a plurality of shelves and a plurality of digital photo collections positioned on the bookshelf wherein the digital photo collections represent types of printed media, and wherein the displayed digital photo collections include at least one digital photo collection that was created based on user input and at least one pre-generated digital photo collection;
a computer-readable medium tangibly encoding instructions executable by the data processing apparatus to perform operations including:
receiving user input indicating a selection of a pre-generated digital photo collection;
receiving user input indicating an image to be included in the selected pre-generated digital photo collection;
generating a digital photo collection based on the selected pre-generated digital photo collection that includes the user indicated image.

33. The system of claim 32, wherein the display device is further configured to display the generated digital photo collection on the bookshelf.
